(19) United States
(12) Patent Application Publication
(10) Pub. No.: US 2011/0243733 A1
(43) Pub. Date: Oct. 6, 2011

(54) SUSPENSION TYPE SWING MECHANISM

(76) Inventor: Hung-Chi CHIEN, Taipei (TW)

(21) Appl. No.: 13/035,928

(22) Filed: Feb. 26, 2011

(30) Foreign Application Priority Data
Mar. 30, 2010 (TW) 099205522

(51) Int. Cl. F04D 25/10; F16H 21/40

(52) U.S. Cl. 416/100; 74/47

(57) ABSTRACT

The present invention provides a suspension type swing mechanism, which comprises: a fastening base, the circumference thereof is radially pivoted with a supporter, and the bottom thereof is installed with an axial hole; a swing member, the bottom thereof is connected to the top of a hung article, and the swing member is installed with an axially-extended axial tube which passes through the axial hole and penetrates into the fastening base; a transmission device, a motor thereof is fixed at the periphery of the axial hole, an output shaft of the motor is connected to the inner end of a crank set, the outer end of the crank set is provide with a sleeve member sleeved on the axial tube for forming a synchronous motion; and an axial rotation device, which further includes a first rolling mechanism installed between the hung article and the fastening base and a second rolling mechanism installed between the fastening base and the swing member; with the output of the motor, the sleeve member at the output end of the crank set drives the axial tube and the hung article to to-and-fro swing at a pre-determined angle.

### BACKGROUND OF THE INVENTION

1. Field of the Invention

The present invention relates to a suspension type swing mechanism, especially to a suspension type swing mechanism connected between a fastening base and a hung article, the suspension type swing mechanism is capable of enabling to the hung article to swing in a to-and-fro manner at a pre-determined angle.

2. Description of Related Art

A swing mechanism is commonly seen in our lives, for example a cooling fan or a hot air fan, which is a design of to-and-fro swinging according to a pre-determined angle. On the other hand, fixing an article with a suspension means is often designed for corresponding to the installation environment.

Take a cool or hot air fan for instance, a conventional to-and-fro swing mechanism generally comprises an upright supporter, and a casing body equipped with an axial flow or centrifugal type fan and pivoted on the supporter, and meanwhile an eccentric output of a motor drives a crank set then a pivotal shaft is driven, such that the casing body capable of outputting cool or hot air can be to-and-fro swung at a pre-determined angle.

The mentioned to-and-fro swing mechanism has been developed for years, and the mechanism can achieve the basic function of driving a casing body to swing; but one disadvantage is that when the casing body capable of outputting cold or hot air is operated, the swing motion often exceeds the outlines of the supporter; as such, while being installed and positioned, a certain space has to be reserved for allowing the casing body to to-and-fro swing. Moreover, in an open or public location, the mentioned to-and-fro swing mechanism may generate some safety issues.

The Taiwan Utility Model Publication No. M274459 (corresponding to the U.S. Pat. No. 7,244,149 and the China Patent No. 200520119279.1) titled in “Suspension type oscillation mechanism” issued the present applicant has over come several shortages of conventional to-and-fro swing mechanism. With the suspension type swing mechanism, a hung article can be to-and-fro swung at a pre-determined angle inside a supporter set, so the swing motion is confined in the supporter set due to the suspension means, and no space is required to be reserved for the to-and-fro swing motion of the casing body, so operation safety is provided and consumers have positive responses to the final products.

### SUMMARY OF THE INVENTION

One primary object of the present invention is to provide a suspension type swing mechanism, wherein a hung object is installed at the bottom of a fastening base, so the hung object is able to be to-and-fro swung in a supporter according to a pre-determined angle, and the production cost is greatly reduced and the operation safety is enhanced.

For achieving the mentioned object, one solution according to the present invention is to provide a suspension type swing mechanism, which comprises:

a fastening base, the circumference thereof is radially pivoted with a supporter, and the bottom thereof is installed with an axial hole;

a swing member, the bottom thereof is connected to the top of a hung article, and the swing member is installed with an axially-extended axial tube which passes through the axial hole and penetrates into the fastening base;

a transmission device, a motor thereof is fixed at the periphery of the axial hole, an output shaft of the motor is connected to the inner end of a crank set, the outer end of the crank set is provide with a sleeve member sleeved on the axial tube for forming a synchronous motion; and

an axial rotation device, which further includes:

a first rolling mechanism, wherein a bottom ring is installed at the bottom of the swing member so the outer end of the bottom ring is adjacent to the hung article and is linked to swing with the swing member; a top ring is provided and combined on top of the bottom ring, so the top of the top ring is adjacent to the fastening base, the two rings are passed through by the axial tube, and engaging surfaces of the two rings are respectively and oppositely formed with an annular rail for receiving a plurality of rolling balls and allowing the rolling balls to roll therein; and

a second rolling mechanism, wherein an outer ring is fixed in the axial hole, so the bottom surface of the outer ring is adjacent to and presses against the top ring, an inner ring is provided and combined on top of the outer ring, so the inner ring is sleeved with the axial tube, and engaging surfaces of the two rings are respectively and oppositely formed with an annular rail for receiving a plurality of rolling balls and allowing the rolling balls to roll therein; with the output of the motor, the sleeve member at the output end of the crank set drives the axial tube and the hung article to to-and-fro swing at a pre-determined angle.

### BRIEF DESCRIPTION OF THE DRAWINGS

FIG. 1 is a perspective exploded view illustrating the suspension type swing mechanism according to the present invention;

FIG. 2 is a perspective view illustrating the semi-assembled product according to the present invention;

FIG. 3 is a cross sectional view illustrating the assembled suspension type swing mechanism according to the present invention;

FIG. 4 is a perspective view illustrating the assembled suspension type swing mechanism according to the present invention.

### DETAILED DESCRIPTION OF THE PREFERRED EMBODIMENT

According to following embodiments of the present invention, the suspension type swing mechanism can be adopted in, e.g. but not limited to, a hot air fan, especially a ceramic electric heating fan; alternatively, a cooling fan, fan, air filter, light device, photographic device, monitor, etc. can also adopt the suspension type swing mechanism provided by the present invention.

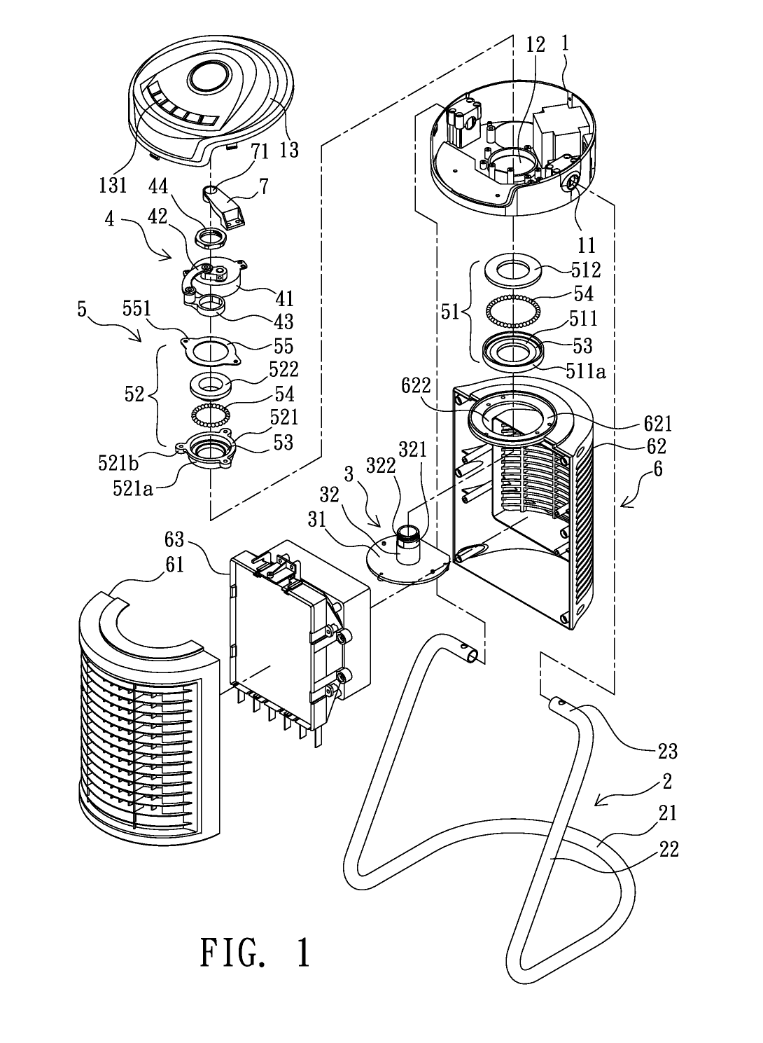

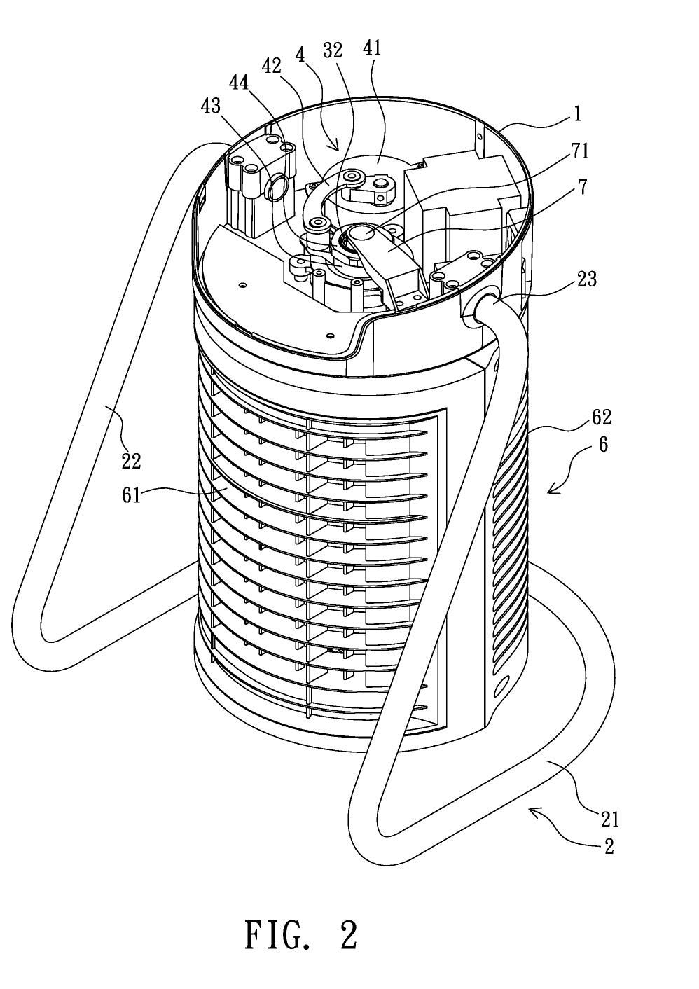

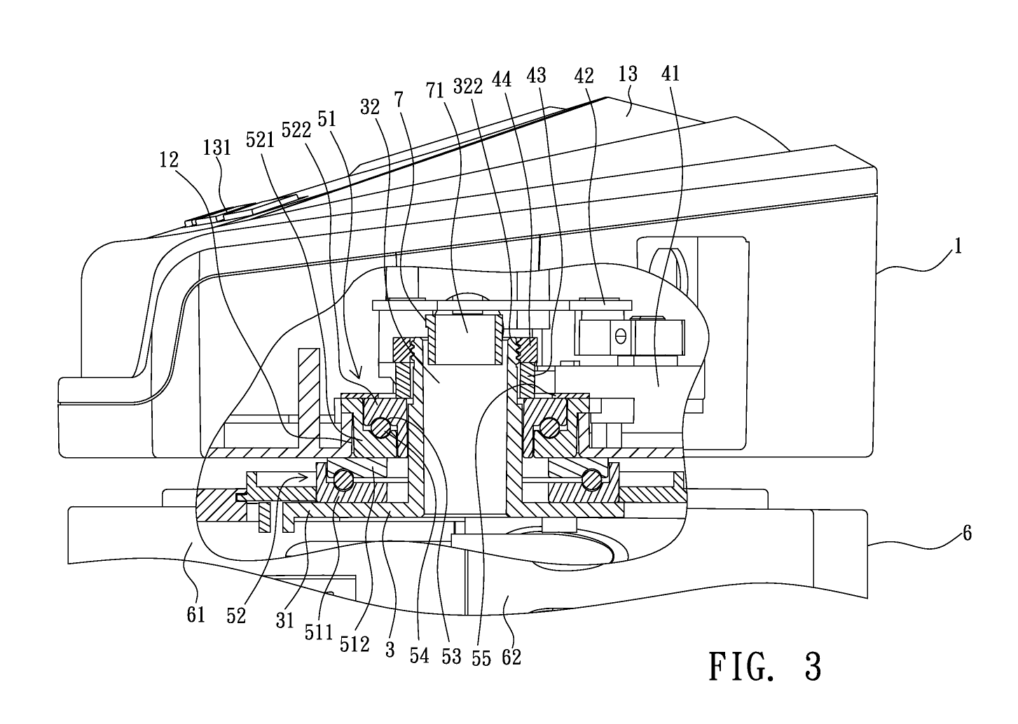

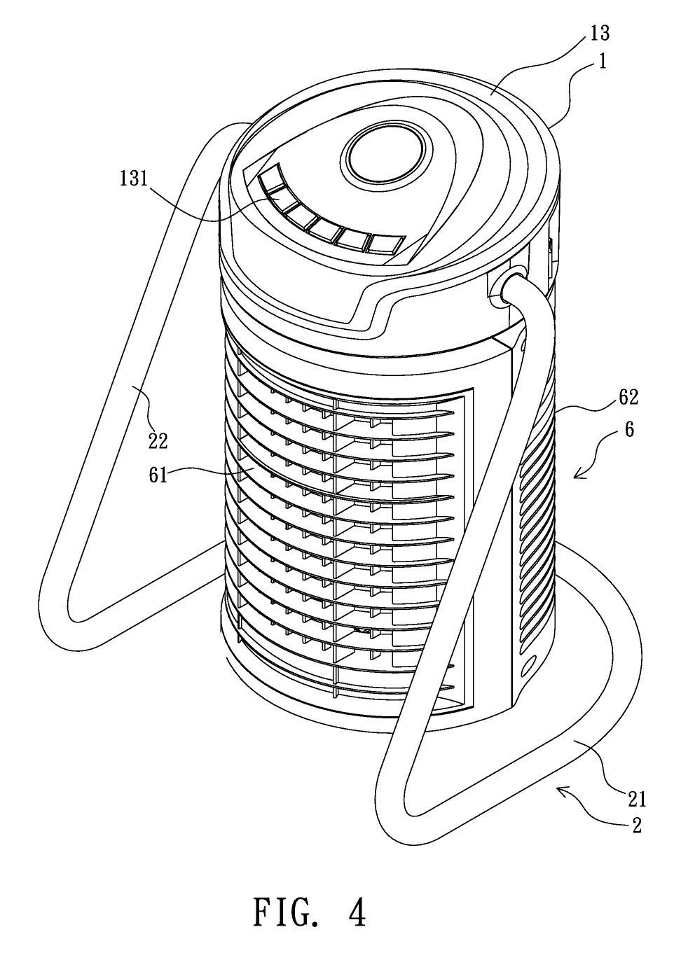

For fully disclosing the characteristics of the present invention, please referring to FIG. 1 to FIG. 4, wherein FIG. 1 is a perspective exploded view showing the suspension type swing mechanism according to the present invention; FIG. 2 is a perspective view showing the semi-assembled product according to the present invention; FIG. 3 is a cross sectional view showing the assembled suspension type swing mechanism according to the present invention; FIG. 4 is a perspective view showing the assembled suspension type swing mechanism according to the present invention.

As shown from FIG. 1 to FIG. 4, according to the present invention, the suspension type swing mechanism substantially consists of a fastening base 1, a supporter 2, a swing member 3, a transmission device 4, an axial rotation device 5 and a hung article 6.

The fastening base 1 is a base member wherein the top thereof being opened for the installation of transmission device 4. The circumference of the fastening base 1 is radially and oppositely installed with a pair of pivot holes 11 for being combined to the supporter 2, such that the fastening base 1 is installed and fastened on the top of the supporter 2. Moreover, for forming a suspending function, the bottom of the fastening base 1 is provided with an axial hole 12 for allowing an axial tube 32 of the swing member 3 to penetrate so as to be installed on the transmission device 4, such that the swing member 3 is capable of to-and-fro swinging at a pre-determined angle.

The opening on the top of the fastening base 1 is sealed by a top cover 13. The interior of the top cover 13 is provided with a conventional control circuit board (not shown) which can be controlled by a button set 131 exposed outside the top cover 13, for the controls of power ON/OFF, setting operation timing, adjusting wing speed, switching hot air modes and whether turning on the swinging function; the mentioned controls for the hot air fan are commonly known by skilled people in the art so no further illustration is provided.

The supporter 2 is a rack member pivoted to the fastening base 1 for regulating the hung article 6, which is suspended below the fastening base 1, to be confined in a space surrounded by the supporter 2. As shown in FIG. 1, the bottom of the supporter 2 is installed with a C-shaped bottom rack 21 with a forward-facing opening, and a pair of support arms 22 is obliquely and upwardly extended from two ends of the opening of the bottom rack 21. Support shafts 23 inwardly extended from the top of the pair of support arms 22 are installed in the pivot holes 11 radially and oppositely provided in the fastening base 1.

The swing member 3 is installed on the top of the hung article 6, as shown in FIG. 1 and FIG. 3, the periphery of a bottom connection sheet 31 of the swing member 3 is abutted against the inner wall of an engagement ring 621 installed at the top of a rear shell 62 of the hung article 6, then conventional connecting members, e.g. screws, are provided for fixing the bottom connection sheet 31 on the engagement ring 621, such that an axial tube 32 axially protruding from the bottom connection sheet 31 upwardly penetrates a ring hole 622 defined at the center of the engagement ring 621, so as to be connected to the axial rotation device 5, then be connected to the transmission device 4. As such, the swing member 3 can be controlled through the transmission device 4 for to-and-fro swinging at a pre-determined angle.

The transmission device 4 is installed at the periphery of the axial hole 12 of the fastening base 1. The transmission device 4 includes a motor 41 e.g. a synchronous motor, an output shaft of the motor 41 is connected to the inner end of a crank set 42, and the outer end of the crank set 42 is installed with a sleeve member 43. The sleeve member 43 is a noncircular aperture and sleeved at a passive portion 321 correspondingly formed at the exterior of the axial tube 32. As such, when the motor 41 is operated, the sleeve member 43 at the output end of the crank set 42 drives the axial tube 32 of the swing member 3 to to-and-fro swing at a pre-determined angle.

The axial rotation device 5 is provided for reducing the friction and wearing between the fastening base 1 and the swing member 3, meanwhile the operation of swing member 3 is enhanced to be smoother. As shown in FIG. 1 and FIG. 3, the axial rotation device 5 includes a first rolling mechanism 51 provided between the hung article 6 and the fastening base 1, and a second rolling mechanism 52 provided between the fastening base 1 and the swing member 3; and the two rolling mechanisms 52, 51, which are adjacent disposed in a vertical fashion, are penetrated by the axial tube 32 of the swing member 3.

A bottom ring 511 of the first rolling mechanism 51 is installed in the ring hole 622, so the bottom surface of the bottom ring 511 is adjacent to the bottom connection sheet 31 of the swing member 3 and is linked to be swung; and a top ring 512 is provided above the bottom ring 511, wherein engaging surfaces of the two rings 511, 512 are respectively and oppositely installed with an annular rail 53 for receiving plural rolling balls 54 and allowing the rolling balls 54 to roll therein. Moreover, the circumference of the bottom ring 511 is vertically installed with a block wall 511a abutted against the outer periphery of the top ring 512 for preventing the top ring 512 from being radially released.

An outer ring 521 of the second rolling mechanism 52 is installed in the axial hole 12, and a plurality of convex lugs 521b are radially extended from the top of a block wall 521a vertical to the circumference of the outer ring 521, and each convex lug 521b is fixed on convex columns preset at the periphery of the axial hole 12, so the bottom surface of the outer ring 521 is adjacent to and presses against the top ring 512; then an inner ring 522 is combined on top of the outer ring 521, wherein engaging surfaces of the two rings 521, 522 are respectively and oppositely installed with an annular rail 53 for receiving plural rolling balls 54 and allowing the rolling balls 54 to roll therein. The inner ring 522 is in a reversed-L shape so the inner diameter being able to be sleeved in the axial tube 32 and linked to swing therewith. Lastly extending parts 551 at two ends of a pressing ring sheet 55 are locked on the convex columns preset at the periphery of the axial hole 12, such that the pressing ring sheet 55 presses against the engaging surfaces on the tops of the inner and outer rings 522, 521, so the inner ring 522 is prevented from being axially released.

Beside the rolling balls 54, the first and second rolling mechanisms 51, 52 are formed through plastic injection molding, and the interiors of the two rolling mechanisms are not installed with retainers which serve to regulate balls rolling inside a bearing, so the production cost can be greatly saved; and with the installation of the two rolling mechanisms, the conventional expensive bearing can be replaced.

When the axial tube 32 passes through the first and second rolling mechanisms 51, 52, and the passive portion 321 of the axial tube 32 is sleeved with the sleeve member 43 at the output end of the crank set 42, lastly an end sealing member 44, e.g. a nut, is connected to a thread connection portion 322 formed on the top of the axial tube 32, so the sleeve member 43 is prevented from being axially released.

The hung article 6 is composed through a front shell 61 engaging with a rear shell 62; as mentioned above, the engagement ring 621 on the top of the rear shell 62 is connected to the swing member 3, and the interior of the hung article 6 is installed with a device, e.g. but not limited to a ceramic electric heating device 63. Wires of the ceramic electric heating device 63 are passed through the axial tube 32 and connected to the circuit board inside the top cover 13.

According to the present invention, a partition member 7 can be further provided, the outer end thereof is fixed at the convex columns installed at the periphery of the axial hole 12 formed inside the fastening base 1, an partition tube 71 axially extended at the inner end penetrates in the axial tube 32, so when the transmission device 4 is operated and the axial tube 32 of the swing member 3 are to-and-fro swung, the wires are prevented from rubbing against the inner wall of the axial tube 32.

As shown in FIG. 2, which is perspective view of the above mentioned assembly without the top cover 13 being combined with the fastening base 1; as shown in FIG. 2, the partition tube 71 of the partition member 7 is inserted in the axial tube 32, and the end sealing member 44 is connected to the connection portion 322 formed on the top of the axial tube 32, such that the bottom of the end sealing member 44 is adjacent to the sleeve member 43 at the output end of the crank set 42.

As such, when the motor 41 is operated, the sleeve member 43 at the output end of the crank set 42 is to-and-fro swung at a pre-determined angle, because the axial tube 32 is driven by the sleeve member 43, the hung article 6 connected to the swing member 3 is also to-and-fro swung at a pre-determined angle with respect to the fastening base 1 and the supporter 2.

As shown in FIG. 3, which is a partially-enlarge view of the swing member 3, the top of the hung article 6, the first rolling mechanism 51, the bottom of the fastening base 1, the second rolling mechanism 52, the sleeve member 43, the end sealing member 44 and the partition tube 71. Referring to FIG. 3, the inner ring 522 can to-and-fro swing with the axial tube 32, and the outer ring 521, which is in a fixed state, presses against the top ring 512, and the bottom ring 511 can to-and-fro swing with the bottom connection sheet 31, so the first and second rolling mechanisms 51, 52 respectively provide the radial and axial lubrications and a stable swinging effect. And as shown in FIG. 4, which is a perspective view showing the opening at the top of the fastening base 1 being sealed by the top cover 13.

The advantages of the present invention are as followings: the top of the supporter is directly pivoted to the fastening base, and the transmission device inside the fastening base is connected to the hung article through the swing member, and the first rolling mechanism of the axial rotation device is installed between the hung article and the fastening base, and the second rolling mechanism is installed between the fastening base and the swing member. As such, the hung article is enabled to swing at a pre-determined angle in the fastening base and the supporter, and the swing motion is restrained within the supporter due to the suspension means. Moreover, the present invention utilizes the first and second rolling mechanisms to replace expensive radial and axial bearings, and the swing member is able to smoothly operate without increasing friction and wearing, and the production cost can be greatly reduced and the operation safety is enhanced.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A suspension type swing mechanism, comprising:
a fastening base, the circumference thereof being radially pivoted with a supporter, and the bottom thereof being installed with an axial hole;
a swing member, the bottom thereof being connected to the top of a hung article, and said swing member being installed with an axially-extended axial tube which upwardly passing through said axial hole and penetrating into said fastening base;
a transmission device, a motor thereof being fixed at the periphery of said axial hole, an output shaft of said motor being connected to the inner end of a crank set, the outer end of said crank set being provide with a sleeve member sleeved on said axial tube for forming a synchronous motion; and
an axial rotation device, which further including:
a first rolling mechanism, wherein a bottom ring being installed at the bottom of said swing member, so the outer end of said bottom ring being adjacent to said hung article and is linked to swing with said swing member; a top ring being provided and combined on top of said bottom ring, so the top of said top ring being adjacent to said fastening base, said two rings being passed through by said axial tube, and engaging surfaces of said two rings being respectively and oppositely formed with an annular rail for receiving a plurality of rolling balls and allowing said rolling balls to roll therein; and
a second rolling mechanism, wherein an outer ring being fixed in said axial hole, so the bottom surface of said outer ring being adjacent to and pressing against said top ring, an inner ring being provided and combined on top of said outer ring, so said inner ring being sleeved with said axial tube, and engaging surfaces of said two rings being respectively and oppositely formed with an annular rail for receiving a plurality of rolling balls and allowing said rolling balls to roll therein; with the output of said motor, said sleeve member at the output end of said crank set driving said axial tube and said hung article to to-and-fro swing at a pre-determined angle.

2. The suspension type swing mechanism according to claim 1, wherein an opening formed at the top of said fastening base is sealed by a top cover, and the interior of said top cover is installed with a control circuit board electrically connected to a button set which is exposed outside said top cover.

3. The suspension type swing mechanism according to claim 1, wherein the bottom of said supporter is installed with a C-shaped bottom rack with a forward-facing opening, and a pair of support arms is obliquely and upwardly extended from two ends of said opening of said bottom rack; support shafts inwardly extended from the top of said pair of support arms are installed in pivot holes radially and oppositely formed in said fastening base.

4. The suspension type swing mechanism according to claim 1, wherein the bottom of said swing member is installed with a bottom connection sheet, the periphery of said bottom connection sheet is abutted against and fixed in an engagement ring installed at the top of said hung article, such that said axial tube axially protruding from said bottom connection sheet upwardly penetrates a ring hole defined at the center of said engagement ring.

5. The suspension type swing mechanism according to claim 1, wherein said sleeve member has a noncircular aperture which is sleeved on a passive portion correspondingly formed at the exterior of said axial tube, and an end sealing member is provided and combined on a connection portion formed above said passive portion, so the bottom of said end sealing member is adjacent to said sleeve member.

6. The suspension type swing mechanism according to claim 1, wherein the circumference of said bottom ring is vertically installed with a block wall abutted against the outer end of said top ring.

7. The suspension type swing mechanism according to claim 1, wherein a plurality of convex lugs are radially extended from the top of a block wall vertical to the circumference of said outer ring, and each convex lug is fixed on convex columns preset at the periphery of said axial hole.

8. The suspension type swing mechanism according to claim 1, wherein said axial rotation device further includes a pressing ring sheet, two ends thereof are locked on said convex columns preset at the periphery of said axial hole, such that said pressing ring sheet presses against the engaging surfaces on the tops of said inner and outer rings of said second rolling mechanism.

9. The suspension type swing mechanism according to claim 1, further including a partition member, the outer end thereof is fixed at the periphery of said axial hole, a partition tube axially extended at the inner end penetrates in said axial tube.

10. The suspension type swing mechanism according to claim 1, wherein said hung article is composed of a front shell engaging with a rear shell, and said hung article is a cooling fan, a fan, a hot air fan or an air filter.
